(19) United States
(12) Patent Application Publication
(10) Pub. No.: US 2022/0138705 A1
(43) Pub. Date: May 5, 2022

(54) Search Engine with Automated Blockchain-Based Smart Contracts

(71) Applicant: Brianson IP, LLC, Casper, WY (US)

(72) Inventor: Brian D. Wright, Lake Orion, MI (US)

(21) Appl. No.: 17/519,343

(22) Filed: Nov. 4, 2021

Related U.S. Application Data
(60) Provisional application No. 63/109,489, filed on Nov. 4, 2020.

(51) Int. Cl. G06Q 20/06; G06Q 20/36; H04L 9/32

(52) U.S. Cl. CPC G06Q 20/065; G06Q 20/36; H04L 2209/56; H04L 2209/38; H04L 9/3213

(57) ABSTRACT

Search Engine with automated blockchain-based smart contracts. In an embodiment, a user may utilize a search engine to search properties, select a property, and accept an agreement related to the property. After the agreement is approved, a smart contract, representing the agreement, may be automatically generated from a template, compiled, and deployed to a blockchain. The smart contract may be generated to comprise functions that enable the user to add properties to the agreement by sending different types of crypto tokens to the smart contract as transactions on the blockchain.

### CROSS-REFERENCE TO RELATED APPLICATIONS

This application claims priority to U.S. Provisional Patent App. No. 63/109,489, filed on Nov. 4, 2020, which is hereby incorporated herein by reference as if set forth in full.

### BACKGROUND

### Field of the Invention

The embodiments described herein are generally directed to smart contracts on a blockchain, and, more particularly, to a search engine for properties that automates the implementation of blockchain-based smart contracts to enforce agreements related to those properties.

### Description of the Related Art

Today, all types of things can be sold online, including personal and real property. For example, a first user of an online platform may advertise a property on a listing site (e.g., eBay™ Craigslist™, RedFin™, etc.) or in an online database (e.g., the Multiple Listing Service (MLS) for real estate) hosted by the online platform. A second user of the online platform may then utilize a search engine, hosted by the online platform, to view property for sale or lease. Typically, the search engine provides conventional sorting and filtering to enable the second user to identify properties satisfying one or more criteria of interest to the second user. For example, in the case of real property, the second user may specify a location (e.g., city or Zip code), a price range (e.g., minimum and maximum listing price), a number of bedrooms, a number of bathrooms, a square footage, and/or the like. The online platform may also enable the second user to communicate or initiate communication with the first user (e.g., directly in the case of personal property, or through an agent in the case of real property) to facilitate and/or complete a transaction, such as the second user's purchase or lease of the property advertised by the first user.

However, while such platforms may work adequately to establish a contract, users that enter into an extended agreement, such as a lease agreement for the property over an extended period of time, must manually enforce that agreement over the lifetime of the contract. In addition, any changes to the contract must be manually implemented (e.g., via notification and renegotiation).

### SUMMARY

Accordingly, systems, methods, and non-transitory computer-readable media are disclosed for a search engine that automates the generation of blockchain-based smart contracts to implement self-executing and expandable agreements. Embodiments represent an improvement to existing search engines, address obstacles preventing the automatic creation of smart contracts, and enable flexibility in otherwise immutable smart contracts on the blockchain.

In an embodiment, a method comprises using at least one hardware processor to: receive one or more search criteria from a first user; search a database of a plurality of properties based on the one or more search criteria to produce search results comprising one or more of the plurality of properties; receive a selection of at least one property, associated with a second user, from the one or more properties in the search results; receive one or more user operations from one or both of the first user or the second user representing approval of an agreement associated with the at least one property; and, after approval of the agreement, select a template for a smart contract, from a plurality of available templates, based on one or both of the agreement or the at least one property, generate a smart contract based on the template and one or both of the agreement or the at least one property, compile the smart contract, and deploy the compiled smart contract on a blockchain.

The smart contract may comprise one or more functions for accepting a plurality of different types of tokens that are each exchangeable on the blockchain. The plurality of different types of tokens may comprise a token type representing each of a plurality of different types of property. The smart contract may be configured to, when receiving a request with a token representing a new type of property, update a stored state, representing the agreement, to include the new type of property. The plurality of different types of property may comprise real property and personal property. The plurality of different types of property may further comprise a service. The method may further comprise deploying a single smart contract on the blockchain to generate and manage the plurality of different tokens. The single smart contract may comply with Ethereum Request for Comment 1155 (ERC-1155) standard.

The template may comprise source code of the smart contract and one or more placeholders configured to receive parameter values specific to the agreement.

The agreement may be a sales agreement, lease agreement, or lease-to-own agreement. The smart contract may be configured to automatically execute a transfer of value on the blockchain from a digital wallet of the first user to a digital wallet of the second user according to a payment term in the agreement. The transfer of value may comprise a transfer of an amount of tokens.

The method may further comprise using the at least one hardware processor to, prior to deploying the compiled smart contract, validate a behavior of the compiled smart contract.

The method may further comprise using the at least one hardware processor to: receive property data for the at least one property from the second user via an application programming interface or a graphical user interface; generate a unique property identifier for the at least one property; and store the property data in the database of the plurality of properties in association with the unique property identifier.

The method may further comprise using the at least one hardware processor to: receive one or more media for the at least one property from the second user via an application programming interface or a graphical user interface; and store the one or more media in a media database, which is separate from the database of the plurality of properties, in association with the unique property identifier.

Receiving the one or more user operations may comprise: receiving a selection of a call-to-action input, indicating acceptance of the agreement, by the first user within a graphical user interface; providing an approval request to the second user; and receiving an acceptance of the agreement from the second user. Receiving the one or more user operations may further comprise, prior to providing the approval request to the second user: communicating with one or more external systems over at least one network to perform one or more of a verification process, security authentication process, or credit approval process on the first user; and receiving a result from the one or more external systems, wherein the approval request comprises an indication of the result.

Receiving a selection of at least one property may comprise receiving a selection of one or more options from a plurality of available options for terms of the agreement associated with the at least one property.

Any of the methods above may be embodied, individually or in any combination, in executable software modules of a processor-based system, such as a server, and/or in executable instructions stored in a non-transitory computer-readable medium.

### BRIEF DESCRIPTION OF THE DRAWINGS

The details of the present invention, both as to its structure and operation, may be gleaned in part by study of the accompanying drawings, in which like reference numerals refer to like parts, and in which:

FIG. 1 illustrates an example infrastructure, in which one or more of the processes described herein, may be implemented, according to an embodiment;

FIG. 2 illustrates an example processing system, by which one or more of the processes described herein, may be executed, according to an embodiment;

FIG. 3 illustrates an example process for searching properties and automatically generating a blockchain-based smart contract representing an agreement for a property, according to an embodiment; and

FIG. 4 illustrates an example process for expanding the agreement represented by a smart contract, according to an embodiment.

### DETAILED DESCRIPTION

In an embodiment, systems, methods, and non-transitory computer-readable media are disclosed for a search engine with automated blockchain-based smart contracts representing property agreements. As used herein, the term “property” may refer to anything that can be owned or provided by an individual, organization (e.g., for-profit or non-profit company, government agency, educational institution, etc.), or other entity. For example, property may include real property, such as an apartment, condominium, single-family home, multi-family home, commercial retail space, commercial office space, commercial building (e.g., warehouse, factory, plant, etc.), farm, vacant land, and/or the like. Property may also include personal or business property, such as a vehicle (e.g., automobile, motorcycle, bicycle, scooter, airplane, helicopter, boat, etc.), furniture, electronic devices, machinery, clothes, digital asset (e.g., NFT), and/or the like. As used herein, property may also include a service which an entity has the right to provide, such as a utility service (e.g., electric power, water, Internet, telephone, cable or satellite television, etc.), subscription service (e.g., gaming, streaming content, etc.), cleaning service (e.g., house cleaning, pool cleaning, etc.), professional service (e.g., legal, medical, accounting, etc.), and/or the like.

After reading this description, it will become apparent to one skilled in the art how to implement the invention in various alternative embodiments and alternative applications. However, although various embodiments of the present invention will be described herein, it is understood that these embodiments are presented by way of example and illustration only, and not limitation. As such, this detailed description of various embodiments should not be construed to limit the scope or breadth of the present invention as set forth in the appended claims.

1. System Overview

1.1. Infrastructure

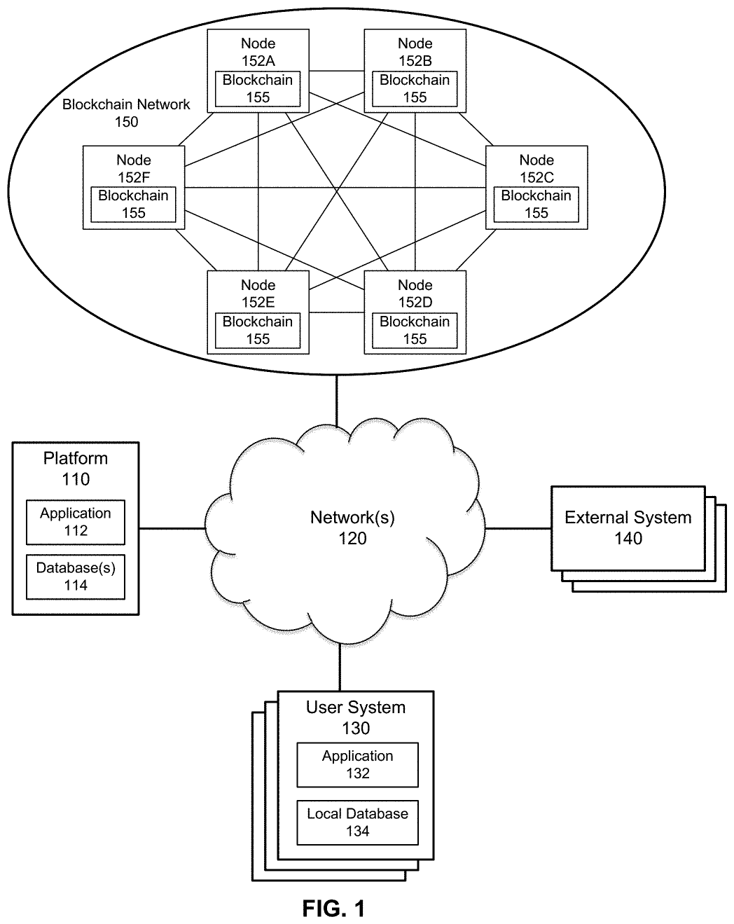

FIG. 1 illustrates an example infrastructure in which one or more of the disclosed processes may be implemented, according to an embodiment. The infrastructure may comprise a platform 110 (e.g., one or more servers) which hosts and/or executes one or more of the various functions, processes, methods, and/or software modules described herein. Platform 110 may comprise dedicated servers, or may instead comprise cloud instances, which utilize shared resources of one or more servers. These servers or cloud instances may be collocated and/or geographically distributed. Platform 110 may also comprise or be communicatively connected to a server application 112 (e.g., comprising the disclosed search engine) and/or one or more databases 114 (e.g., supporting the disclosed search engine). In addition, platform 110 may be communicatively connected to one or more user systems 130 via one or more networks 120. Platform 110 may also be communicatively connected to one or more external systems 140 (e.g., other platforms, websites, etc.) via network(s) 120.

Platform 110 may also be connected to a blockchain network 150 via network(s) 120. Blockchain network 150 comprises a plurality of nodes 152. Each node 152 may comprise a computing system that stores a complete copy of a blockchain 155. Blockchain 155 represents a public ledger of all transactions managed by blockchain network 150. In an embodiment, blockchain 155 supports smart contracts. For example, blockchain 155 may be the Ethereum blockchain, as initially described in “A Next-Generation Smart Contract and Decentralized Application Platform,” by Vitalik Buterin, 2013, which is hereby incorporated herein by reference as if set forth in full. Other examples of blockchains that support smart contracts include Aeternity, Cardano, Qtum, Stellar, Waves, Neo, New Economic Movement (NEM), and the like.

As is well-known in the art, blockchain 155 is an open, distributed ledger that is resistant to modification. Specifically, blockchain 155 comprises a plurality of chronologically arranged blocks that are chained together using cryptography. As transactions are created, batches of valid transactions are packaged into a new block along with a cryptographic hash of the most recent block added to blockchain 155. A cryptographic hash of the new block is then generated and the new block with its cryptographic hash is added to blockchain 155. In theory, blockchain 155 could be altered. However, since the blocks are chained together via their cryptographic hashes, in order to alter blockchain 155, the entire blockchain 155 would need to be recomputed, thereby rendering such an undertaking computationally impractical.

Within blockchain network 150, each node 152 is capable of validating transactions, generating new blocks, and broadcasting generated blocks to the other nodes 152. Since multiple nodes 152 may generate and broadcast new blocks, a consensus method may be used to select the next block to be added to blockchain 155. For example, in a blockchain 155 that uses a proof-of-work method, temporary forks may result with different nodes 152 having different versions of blockchain 155, but eventually the chain with the most cumulative proof-of-work will win out. In an embodiment, blockchain network 150 utilizes a proof-of-stake method, in which a node is selected to produce the next valid block in blockchain 155, based on the node's stake (e.g., value at stake and/or age) in blockchain 155. Proof-of-stake methods prevent malicious actors by ensuring that they have a vested interest in the integrity of blockchain 155.

Network(s) 120 may comprise the Internet, and platform 110 may communicate with user system(s) 130 through the Internet using standard transmission protocols, such as HyperText Transfer Protocol (HTTP), HTTP Secure (HTTPS), File Transfer Protocol (FTP), FTP Secure (FTPS), Secure Shell FTP (SFTP), and the like, as well as proprietary protocols. While platform 110 is illustrated as being connected to various systems through a single set of network(s) 120, it should be understood that platform 110 may be connected to the various systems via different sets of one or more networks. For example, platform 110 may be connected to a subset of user systems 130, external systems 140, and/or one or more nodes 152 in blockchain network 150 via the Internet, but may be connected to one or more other user systems 130, external systems 140, and/or nodes 152 via an intranet. Furthermore, while only a few user systems 130, external systems 140, and nodes 152, one server application 112, and one set of database(s) 114 are illustrated, it should be understood that the infrastructure may comprise any number of user systems 130, external systems 140, nodes 152, server applications 112, and databases 114.

User system(s) 130 may comprise any type or types of computing devices capable of wired and/or wireless communication, including without limitation, desktop computers, laptop computers, tablet computers, smart phones or other mobile phones, servers, game consoles, televisions, set-top boxes, electronic kiosks, point-of-sale terminals, and/or the like. However, it is contemplated that user systems 130 would generally comprise the personal devices (e.g., smartphone, tablet computer, laptop computer, desktop computer, etc.) and/or work devices (e.g., workstations) of those utilizing platform 110 to post properties and/or enter agreements for properties.

Platform 110 may comprise web servers which host one or more websites and/or web services. In embodiments in which a website is provided, the website may comprise a graphical user interface, including, for example, one or more screens (e.g., webpages) generated in HyperText Markup Language (HTML) or other language. Platform 110 transmits or serves one or more screens of the graphical user interface in response to requests from user system(s) 130. In some embodiments, these screens may be served in the form of a wizard, in which case two or more screens may be served in a sequential manner, and one or more of the sequential screens may depend on an interaction of the user or user system 130 with one or more preceding screens. The requests to platform 110 and the responses from platform 110, including the screens of the graphical user interface, may both be communicated through network(s) 120, which may include the Internet, using standard communication protocols (e.g., HTTP, HTTPS, etc.). These screens (e.g., webpages) may comprise a combination of content and elements, such as text, images, videos, animations, references (e.g., hyperlinks), frames, inputs (e.g., textboxes, text areas, checkboxes, radio buttons, drop-down menus, buttons, forms, etc.), scripts (e.g., JavaScript), and the like, including elements comprising or derived from data stored in one or more databases (e.g., database(s) 114) that are locally and/or remotely accessible to platform 110. Platform 110 may also respond to other requests from user system(s) 130.

Platform 110 may further comprise, be communicatively coupled with, or otherwise have access to one or more database(s) 114. For example, platform 110 may comprise one or more database servers which manage one or more databases 114. A user system 130 or server application 112 executing on platform 110 may submit data (e.g., user data, form data, etc.) to be stored in database(s) 114, and/or request access to data stored in database(s) 114. Any suitable database may be utilized, including without limitation MySQL™, Oracle™, IBM™, Microsoft SQL™, Access™, PostgreSQL™, and the like, including cloud-based databases and proprietary databases. Data may be sent to platform 110, for instance, using the well-known POST request supported by HTTP, via FTP, and/or the like. This data, as well as other requests, may be handled, for example, by server-side web technology, such as a servlet or other software module (e.g., comprised in server application 112), executed by platform 110.

In embodiments in which a web service is provided, platform 110 may receive requests from external system(s) 140, and provide responses in eXtensible Markup Language (XML), JavaScript Object Notation (JSON), and/or any other suitable or desired format. In such embodiments, platform 110 may provide an application programming interface (API) which defines the manner in which user system(s) 130 and/or external system(s) 140 may interact with the web service. Thus, user system(s) 130 and/or external system(s) 140 (which may themselves be servers), can define their own user interfaces, and rely on the web service to implement or otherwise provide the backend processes, methods, functionality, storage, and/or the like, described herein. For example, in such an embodiment, a client application 132, executing on one or more user system(s) 130 and potentially using a local database 134, may interact with a server application 112 executing on platform 110 to execute one or more or a portion of one or more of the various functions, processes, methods, and/or software modules described herein. In an embodiment, client application 132 may utilize a local database 134 for storing data locally on user system 130. Client application 132 may be “thin,” in which case processing is primarily carried out server-side by server application 112 on platform 110. A basic example of a thin client application 132 is a browser application, which simply requests, receives, and renders webpages at user system(s) 130, while server application 112 on platform 110 is responsible for generating the webpages and managing database functions. Alternatively, the client application may be “thick,” in which case processing is primarily carried out client-side by user system(s) 130. It should be understood that client application 132 may perform an amount of processing, relative to server application 112 on platform 110, at any point along this spectrum between “thin” and “thick,” depending on the design goals of the particular implementation. In any case, the software described herein, which may wholly reside on either platform 110 (e.g., in which case server application 112 performs all processing) or user system(s) 130 (e.g., in which case client application 132 performs all processing) or be distributed between platform 110 and user system(s) 130 (e.g., in which case server application 112 and client application 132 both perform processing), can comprise one or more executable software modules comprising instructions that implement one or more of the processes, methods, or functions described herein.

1.2. Example Processing Device

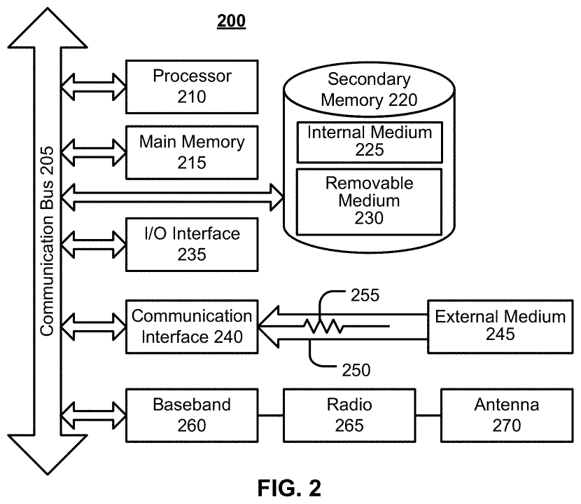

FIG. 2 is a block diagram illustrating an example wired or wireless system 200 that may be used in connection with various embodiments described herein. For example, system 200 may be used as or in conjunction with one or more of the functions, processes, or methods (e.g., to store and/or execute the software) described herein, and may represent components of platform 110, user system(s) 130, external system(s) 140, nodes 152, and/or other processing devices described herein. System 200 can be a server or any conventional personal computer, or any other processor-enabled device that is capable of wired or wireless data communication. Other computer systems and/or architectures may be also used, as will be clear to those skilled in the art.

System 200 preferably includes one or more processors 210. Processor(s) 210 may comprise a central processing unit (CPU). Additional processors may be provided, such as a graphics processing unit (GPU), an auxiliary processor to manage input/output, an auxiliary processor to perform floating-point mathematical operations, a special-purpose microprocessor having an architecture suitable for fast execution of signal-processing algorithms (e.g., digital-signal processor), a slave processor subordinate to the main processing system (e.g., back-end processor), an additional microprocessor or controller for dual or multiple processor systems, and/or a coprocessor. Such auxiliary processors may be discrete processors or may be integrated with processor 210. Examples of processors which may be used with system 200 include, without limitation, any of the processors (e.g., Pentium™, Core i7™, Xeon™, etc.) available from Intel Corporation of Santa Clara, Calif., any of the processors available from Advanced Micro Devices, Incorporated (AMD) of Santa Clara, Calif., any of the processors (e.g., A series, M series, etc.) available from Apple Inc. of Cupertino, any of the processors (e.g., Exynos™) available from Samsung Electronics Co., Ltd., of Seoul, South Korea, and/or the like.

Processor 210 is preferably connected to a communication bus 205. Communication bus 205 may include a data channel for facilitating information transfer between storage and other peripheral components of system 200. Furthermore, communication bus 205 may provide a set of signals used for communication with processor 210, including a data bus, address bus, and/or control bus (not shown). Communication bus 205 may comprise any standard or non-standard bus architecture such as, for example, bus architectures compliant with industry standard architecture (ISA), extended industry standard architecture (EISA), Micro Channel Architecture (MCA), peripheral component interconnect (PCI) local bus, standards promulgated by the Institute of Electrical and Electronics Engineers (IEEE) including IEEE 488 general-purpose interface bus (GPIB), IEEE 696/S-100, and/or the like.

System 200 preferably includes a main memory 215 and may also include a secondary memory 220. Main memory 215 provides storage of instructions and data for programs executing on processor 210, such as one or more of the functions and/or modules discussed herein. It should be understood that programs stored in the memory and executed by processor 210 may be written and/or compiled according to any suitable language, including without limitation C/C++, Java, JavaScript, Perl, Visual Basic, NET, and the like. Main memory 215 is typically semiconductor-based memory such as dynamic random access memory (DRAM) and/or static random access memory (SRAM). Other semiconductor-based memory types include, for example, synchronous dynamic random access memory (SDRAM), Rambus dynamic random access memory (RDRAM), ferroelectric random access memory (FRAM), and the like, including read only memory (ROM).

Secondary memory 220 is a non-transitory computer-readable medium having computer-executable code (e.g., disclosed software) and/or other data stored thereon. The computer software or data stored on secondary memory 220 is read into main memory 215 for execution by processor 210. Secondary memory 220 may include an internal medium 225 and/or a removable medium 230. Removable medium 230 is read from and/or written to in any well-known manner. Removable storage medium 230 may be, for example, a magnetic tape drive, a compact disc (CD) drive, a digital versatile disc (DVD) drive, other optical drive, a flash memory drive, and/or the like.

In alternative embodiments, secondary memory 220 may include other similar means for allowing computer programs or other data or instructions to be loaded into system 200. Such means may include, for example, a communication interface 240, which allows software and data to be transferred from external storage medium 245 to system 200. Examples of external storage medium 245 may include an external hard disk drive, an external optical drive, an external magneto-optical drive, and/or the like. Other examples of secondary memory 220 may include semiconductor-based memory, such as programmable read-only memory (PROM), erasable programmable read-only memory (EPROM), electrically erasable read-only memory (EEPROM), and flash memory (block-oriented memory similar to EEPROM).

As mentioned above, system 200 may include a communication interface 240. Communication interface 240 allows software and data to be transferred between system 200 and external devices (e.g. printers), networks, or other information sources. For example, computer software or executable code may be transferred to system 200 from a network server (e.g., platform 110) via communication interface 240. Examples of communication interface 240 include a built-in network adapter, network interface card (NIC), Personal Computer Memory Card International Association (PCMCIA) network card, card bus network adapter, wireless network adapter, Universal Serial Bus (USB) network adapter, modem, a wireless data card, a communications port, an infrared interface, an IEEE 1394 fire-wire, and any other device capable of interfacing system 200 with a network (e.g., network(s) 120) or another computing device. Communication interface 240 preferably implements industry-promulgated protocol standards, such as Ethernet IEEE 802 standards, Fiber Channel, digital subscriber line (DSL), asynchronous digital subscriber line (ADSL), frame relay, asynchronous transfer mode (ATM), integrated digital services network (ISDN), personal communications services (PCS), transmission control protocol/Internet protocol (TCP/IP), serial line Internet protocol/point to point protocol (SLIP/PPP), and so on, but may also implement customized or non-standard interface protocols as well.

Software and data transferred via communication interface 240 are generally in the form of electrical communication signals 255. These signals 255 may be provided to communication interface 240 via a communication channel 250. In an embodiment, communication channel 250 may be a wired or wireless network (e.g., network(s) 120), or any variety of other communication links. Communication channel 250 carries signals 255 and can be implemented using a variety of wired or wireless communication means including wire or cable, fiber optics, conventional phone line, cellular phone link, wireless data communication link, radio frequency (“RF”) link, or infrared link, just to name a few.

Computer-executable code (e.g., computer programs, such as the disclosed software) is stored in main memory 215 and/or secondary memory 220. Computer programs can also be received via communication interface 240 and stored in main memory 215 and/or secondary memory 220. Such computer programs, when executed, enable system 200 to perform the various functions of the disclosed embodiments as described elsewhere herein.

In this description, the term “computer-readable medium” is used to refer to any non-transitory computer-readable storage media used to provide computer-executable code and/or other data to or within system 200. Examples of such media include main memory 215, secondary memory 220 (including internal memory 225, removable medium 230, and external storage medium 245), and any peripheral device communicatively coupled with communication interface 240 (including a network information server or other network device). These non-transitory computer-readable media are means for providing executable code, programming instructions, software, and/or other data to system 200.

In an embodiment that is implemented using software, the software may be stored on a computer-readable medium and loaded into system 200 by way of removable medium 230, I/O interface 235, or communication interface 240. In such an embodiment, the software is loaded into system 200 in the form of electrical communication signals 255. The software, when executed by processor 210, preferably causes processor 210 to perform one or more of the processes and functions described elsewhere herein.

In an embodiment, I/O interface 235 provides an interface between one or more components of system 200 and one or more input and/or output devices. Example input devices include, without limitation, sensors, keyboards, touch screens or other touch-sensitive devices, cameras, biometric sensing devices, computer mice, trackballs, pen-based pointing devices, and/or the like. Examples of output devices include, without limitation, other processing devices, cathode ray tubes (CRTs), plasma displays, light-emitting diode (LED) displays, liquid crystal displays (LCDs), printers, vacuum fluorescent displays (VFDs), surface-conduction electron-emitter displays (SEDs), field emission displays (FEDs), and/or the like. In some cases, an input and output device may be combined, such as in the case of a touch panel display (e.g., in a smartphone, tablet, or other mobile device).

System 200 may also include optional wireless communication components that facilitate wireless communication over a voice network and/or a data network (e.g., in the case of user system 130). The wireless communication components comprise an antenna system 270, a radio system 265, and a baseband system 260. In system 200, radio frequency (RF) signals are transmitted and received over the air by antenna system 270 under the management of radio system 265.

In an embodiment, antenna system 270 may comprise one or more antennae and one or more multiplexors (not shown) that perform a switching function to provide antenna system 270 with transmit and receive signal paths. In the receive path, received RF signals can be coupled from a multiplexor to a low noise amplifier (not shown) that amplifies the received RF signal and sends the amplified signal to radio system 265.

In an alternative embodiment, radio system 265 may comprise one or more radios that are configured to communicate over various frequencies. In an embodiment, radio system 265 may combine a demodulator (not shown) and modulator (not shown) in one integrated circuit (IC). The demodulator and modulator can also be separate components. In the incoming path, the demodulator strips away the RF carrier signal leaving a baseband receive audio signal, which is sent from radio system 265 to baseband system 260.

If the received signal contains audio information, then baseband system 260 decodes the signal and converts it to an analog signal. Then the signal is amplified and sent to a speaker. Baseband system 260 also receives analog audio signals from a microphone. These analog audio signals are converted to digital signals and encoded by baseband system 260. Baseband system 260 also encodes the digital signals for transmission and generates a baseband transmit audio signal that is routed to the modulator portion of radio system 265. The modulator mixes the baseband transmit audio signal with an RF carrier signal, generating an RF transmit signal that is routed to antenna system 270 and may pass through a power amplifier (not shown). The power amplifier amplifies the RF transmit signal and routes it to antenna system 270, where the signal is switched to the antenna port for transmission.

Baseband system 260 is also communicatively coupled with processor(s) 210. Processor(s) 210 may have access to data storage areas 215 and 220. Processor(s) 210 are preferably configured to execute instructions (i.e., computer programs, such as the disclosed software) that can be stored in main memory 215 or secondary memory 220. Computer programs can also be received from baseband processor 260 and stored in main memory 210 or in secondary memory 220, or executed upon receipt. Such computer programs, when executed, enable system 200 to perform the various functions of the disclosed embodiments.

2. Process Overview

Embodiments of processes for a search engine with automated generation of blockchain-based smart contracts will now be described in detail. It should be understood that the described processes may be embodied in one or more software modules that are executed by one or more hardware processors (e.g., processor 210), for example, as a software application (e.g., server application 112, client application 132, and/or a distributed application comprising both server application 112 and client application 132), which may be executed wholly by processor(s) of platform 110, wholly by processor(s) of user system(s) 130, or may be distributed across platform 110 and user system(s) 130, such that some portions or modules of the software application are executed by platform 110 and other portions or modules of the software application are executed by user system(s) 130. The described processes may be implemented as instructions represented in source code, object code, and/or machine code. These instructions may be executed directly by hardware processor(s) 210, or alternatively, may be executed by a virtual machine operating between the object code and hardware processors 210. In addition, the disclosed software may be built upon or interfaced with one or more existing systems.

Alternatively, the described processes may be implemented as a hardware component (e.g., general-purpose processor, integrated circuit (IC), application-specific integrated circuit (ASIC), digital signal processor (DSP), field-programmable gate array (FPGA) or other programmable logic device, discrete gate or transistor logic, etc.), combination of hardware components, or combination of hardware and software components. To clearly illustrate the interchangeability of hardware and software, various illustrative components, blocks, modules, circuits, and steps are described herein generally in terms of their functionality. Whether such functionality is implemented as hardware or software depends upon the particular application and design constraints imposed on the overall system. Skilled persons can implement the described functionality in varying ways for each particular application, but such implementation decisions should not be interpreted as causing a departure from the scope of the invention. In addition, the grouping of functions within a component, block, module, circuit, or step is for ease of description. Specific functions or steps can be moved from one component, block, module, circuit, or step to another without departing from the invention.

Furthermore, while the processes, described herein, are illustrated with a certain arrangement and ordering of subprocesses, each process may be implemented with fewer, more, or different subprocesses and a different arrangement and/or ordering of subprocesses. In addition, it should be understood that any subprocess, which does not depend on the completion of another subprocess, may be executed before, after, or in parallel with that other independent subprocess, even if the subprocesses are described or illustrated in a particular order.

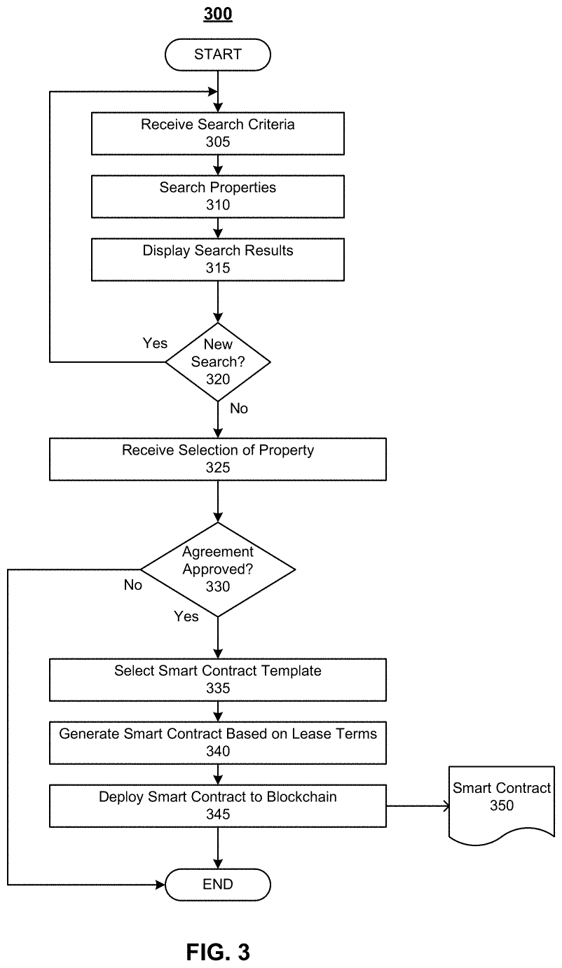

FIG. 3 illustrates an example process 300 for searching properties and automatically generating a blockchain-based smart contract representing an agreement for a property, according to an embodiment. Process 300 may be implemented as software, such as server application 112 hosted on and/or executed by platform 110. Platform 110 may maintain a database (e.g., database 114) of properties that are available for sale and/or lease. Platform 110 may also maintain a media database (e.g., database 114) of media related to the properties in the property database. The media database may be stored in combination with the property database (e.g., in the same database and/or on the same database server) or separately from the property database (e.g., in a separate database and/or on a separate database server). In the event that the media database is stored separately from the property database (e.g., in a distinct media content server), server application 112 may communicate with both databases to store and retrieve properties and their related media using a unique property identifier as an index into both databases. The data stored for a property may comprise, for example, an agreement type (e.g., lease, lease-to-own, purchase, etc.), a property type, media (e.g., images, video, virtual view of walk-through, etc., of the property), owner details (e.g., name, contact information, etc.), location (e.g., street address, city, state, country, Zip code, etc.), attributes (e.g., depending on the property type), available agreement terms, available options for one or more agreement terms (e.g., lease period, payment frequency, etc.), and/or the like.

In an embodiment, the properties are submitted to platform 110 by external system(s) 140. For example, platform 110 may provide a publicly accessible API, supported by server application 112, that implements one or more remote procedure calls for managing properties within the property database and/or managing media related to the properties within the property database. The API for managing properties may be separate from the API for managing media, or a combined API may be provided for managing both properties and media. In an embodiment, a microservices architecture may be used for separately and independently managing the property database and the media database. In any case, each API may require authentication (e.g., via an API key) prior to utilization of one or more, including potentially all, of its functions.

The API may include one or more of the following functions for managing (e.g., adding, updating, deleting, etc.) properties in the property database:
Post function. The post function may accept data representing a new property as input. In response to a call to the post function, server application 112 may generate a unique property identifier, and create a new property record, including the unique property identifier, in the property database, based on the submitted data. The post function may return the unique property identifier to the caller.
Get function. The get function may accept a property identifier. In response to a call to this get function, server application 112 may retrieve the property data associated with that property identifier from the property database. The get function may return the retrieved property data (or an indication that no property exists for the property identifier) to the caller.
Get function. An alternative get function may accept one or more criteria, for example, as a set of query parameters with values. In response to a call to this get function, server application 112 may retrieve the property data associated with any properties that satisfy the one or more criteria from the property database. This get function may return the retrieved property data (or an indication that no property exists for the one or more criteria) to the caller.
Put function. The put function may accept a property identifier of an existing property in the property database and data for the existing property. In response to a call to the put function, server application 112 may update the property associated with the provided property identifier in the property database, based on the data. The put function may return an indication of success, such as the data previously stored for the property prior to the update, (or an indication of failure if no property exists for the provided property identifier or the update failed for some other reason) to the caller.
Delete function. The delete function may accept a property identifier of an existing property in the property database. In response to a call to the delete function, server application 112 may delete the property associated with the provided property identifier in the property data. The delete function may return an indication of success, such as the data previously stored for the property prior to the deletion, (or an indication of failure if no property exists for the provided identifier or the deletion failed for some other reason) to the caller.

The API may include one or more of the following functions for managing (e.g., adding, deleting, etc.) media in the media database:
Post function. The post function may accept a property identifier and one or more media files. In response to a call to the post function, server application 112 may store the media files, in association with the property identifier, in the media database. The post function may return an indication of success or failure to the caller.
Delete function. The delete function may accept a property identifier. In response to a call to the delete function, server application 112 may delete all media files, associated with the property identifier, from the media database. The delete function may return an indication of success or failure to the caller.

Alternatively or additionally, property data and/or media may be provided to server application 112 via a graphical user interface generated by server application 112 and/or client application 132. In particular, a user may register with platform 110 to create a user account via a registration screen of the graphical user interface that accepts various user inputs (e.g., name, email address and/or username, password, contact information, etc.). The user account may be verified by sending an email to a provided email address or a text message to a provided mobile telephone number with a link and/or code that can be used to verify access to the email address or mobile telephone. Subsequently, the user may login to the user account via standard authentication mechanisms (e.g., username and password) to access a dashboard of the user account. The dashboard may comprise inputs or navigation to other screens for submitting properties. The submission of properties may comprise inputting various property data, including a type of agreement available for the property, agreement terms and options available for the property, attributes of the property (e.g., address, dimensions, amenities, description, price, etc.), media related to the property (e.g., images, video, etc.), and/or the like. The required property data may include information necessary to generate a smart contract representing the type of agreement, including the payment term, termination condition, and/or other relevant agreement terms. Platform 110 may store all of the submitted property data within the property database and/or media database.

In subprocess 305, one or more search criteria are received. For example, server application 112 may implement a listing site on which users may post properties (e.g., using the post function(s) or graphical user interface described above). Server application 112 may generate a graphical user interface comprising one or more inputs for specifying search criteria or a plurality of navigable hierarchical screens for selecting search criteria. Each search criterion may essentially comprise a tuple of a parameter and a value of the parameter or a range of values of the parameter. A searching user may specify and submit the one or more search criteria via the input(s) of the graphical user interface. It should be understood that users who post properties represent lessors or sellers of property, whereas searching users represent prospective lessees or purchasers of property.

The specification of the search criteria narrows the search space within the property database. Available search criteria may include, type of agreement (e.g., lease, lease-to-own, or purchase), type of property (e.g., residential real estate, commercial real estate, automobile, furniture, service, etc.), and other attributes of properties. It should be understood that the attributes may depend on the type of agreement and/or the type of property. Thus, the graphical user interface may populate search filters based on the type of agreement and/or type of property that is selected. For example, if the user selects automobile as the property type, the search filters may be populated with inputs for selecting a make, model, year, mileage, color, and/or the like. On the other hand, if the user selects residential real estate as the property type, the search filters may be populated with inputs for selecting a location, price range, square footage, number of bedrooms, and/or the like. In this example, if the user also selected only leasable residential real estate, the search filters may be further populated with criteria of pet-friendliness, available lease terms, and/or the like. Thus, the user can easily combine criteria across various categories of filters to quickly narrow the search space within the property database.

In subprocess 310, the properties in the property database are searched based on the one or more criteria, received in subprocess 305. For example, server application 112 may implement a search engine that searches the property database to retrieve any properties that satisfy the one or more search criteria. In particular, the search engine may compare the value of each parameter in the one or more search criteria to values of parameters in the property data stored in the property database to identify properties whose parameter values match those in the one or more criteria. It should be understood that the search may return, zero, one, or any plurality of search results, with each search result representing a property from the property database.

In subprocess 315, the search results are displayed. For example, for each property in the search results, server application 112 may retrieve all data associated with the property identifier of that property, including any media stored in association with that property identifier in the media database. Server application 112 may then populate the graphical user interface with an entry for each property in the search results (e.g., or a subset of search results if pagination is implemented) in a list, grid, or other format. Each entry may comprise at least a subset of the data retrieved for the property represented by that entry. Each entry may also comprise one or more inputs for viewing additional details about the represented property and/or initiating an agreement (e.g., purchase or lease) related to the represented property.

After reviewing the search results displayed in the graphical user interface, a user may change and/or refine the one or more search criteria. If the user updates the search criteria (i.e., “Yes” in subprocess 320), subprocesses 305-315 may be repeated. Otherwise, if the user selects one of the properties in the search results (i.e., “No” in subprocess 330), the selection of the property is received in subprocess 325. The user may select a property by performing a user operation, such as selecting (e.g., clicking or touching) an input associated with the property in the graphical user interface and/or confirming that the user intends to accept an agreement (e.g., purchase or lease) related to the property.

Subprocess 325 may comprise all steps necessary to form an agreement for the selected property. For example, a user may select a particular entry, representing a particular property, in the search results. In response, the graphical user interface may be updated to display details about the selected property (e.g., values of various attributes in the property data retrieved for the property from the property database), including the terms of a lease and/or purchase agreement associated with the selected property. The graphical user interface may also comprise one or more inputs for selecting and/or approving the agreement terms. A plurality of options (e.g., including a default option) may be provided for each of one or more agreement terms. The user may utilize the input(s) to select an option for each agreement term (e.g., a particular time interval for the payment term). The input(s) may also comprise a call-to-action button (e.g., START MY LEASE™). Thus, the user may review and/or specify the agreement terms and operate the call-to-action button to approve or electronically sign the agreement terms as a first party to the prospective agreement.

In response to the first party approving the agreement terms, server application 112 may request approval from the lessor/seller of the selected property as a second party to the prospective agreement. For example, server application 112 may notify the second party that the first party has accepted the agreement terms. This notification may be performed via a dashboard of a user account of the second party, an email message to an email address of the second party, a text message (e.g., Short Message Service (SMS) or Multimedia Messaging Service (MMS) message) to a mobile number of the second party, and/or the like. If appropriate (e.g., when the lease agreement is for real property or personal property of significant value), server application 112 may also perform a verification process, a security authentication process (e.g., background check), a credit approval process, and/or the like, on the first party, and forward the results of these process(es) to the second party for consideration. In particular, server application 112 may automatically format data about the first party into one or more requests, send the request(s) to one or more external systems 140, receive results of the process(es) from the one or more external systems 140, and package the results into the request for approval that is sent to the second party.

The second party may review the request and either accept or decline the agreement terms. Alternatively, server application 112 could automatically accept or decline the agreement terms, for example, based on one or more of the verification, security authentication, credit approval, and/or other processes. For instance, if one of these processes fail (e.g., the first party cannot be verified, authenticated, or is denied credit), server application 112 may automatically decline the agreement terms on behalf of the second party. Conversely, if all of the processes are successful (e.g., the first party is verified, authenticated, and approved for credit), server application 112 may automatically accept the agreement terms on behalf of the second party. Whether to manually or automatically accept or decline the agreement terms may be a user setting (e.g., specified by the second party) and/or a system setting (e.g., determined by the value of the property, type of property, etc.).

When the agreement terms are accepted by both the first party and the second party, whether manually, semi-automatically (e.g., with user confirmation), or automatically (e.g., without any user intervention), server application 112 determines that the agreement has been approved (i.e., “Yes” in subprocess 330), and process 300 proceeds to subprocess 335. Otherwise, if server application 112 determines that the agreement is rejected (i.e., “No” in subprocess 330), process 300 ends without an agreement.

In subprocess 335, a template is selected for the appropriate smart contract to be used to represent the approved agreement. The template may be selected from a template database (e.g., in database 114), which stores a plurality of templates for various types of smart contracts, based on the type of agreement (e.g., lease, lease-to-own, sale, etc.) and/or the type of property (e.g., residential real property, commercial real property, automobile, furniture, etc.). For example, each type of agreement and/or property may be associated with a particular template. In an alternative embodiment, a single template may be used for all smart contracts, in which case subprocess 335 may be omitted.

A template for a smart contract may comprise the code (e.g., source code) implementing the smart contract with zero, one, or a plurality of placeholders for parameter values representing variable terms (if any) of the agreement, such as the payment terms (e.g., lease price, pay period, number of pay periods, specific date(s) that payment is due, specific condition(s) under which payment is due, etc.) and/or other lease terms (e.g., termination conditions, breach conditions, identifiers of parties that can access the smart contract, etc.). In an embodiment, one or more templates for the smart contracts are designed to encompass a plurality of different properties, such that the agreement, embodied in the smart contract, can be subsequently expanded to include other properties, as discussed elsewhere herein.

In subprocess 340, a smart contract is generated based on the template and the specific terms of the approved agreement. For example, parameters values, representing the agreement terms, may be incorporated into the placeholders in the template of the code for the smart contract. The source code may then be compiled into bytecode (e.g., for execution by nodes 152 on a virtual machine, such as the Ethereum virtual machine if blockchain 155 is Ethereum). In an embodiment, the smart contract may be validated in a test environment to ensure that the smart contract behaves in the intended manner. For example, server application 112 may send the source code or bytecode to one or more external systems 140 over network(s) 120 to be validated, and responsively receive a validation result from the external system(s) 140. If the validation result indicates that the smart contract has been successfully validated, process 300 may proceed to subprocess 345. Otherwise, if the validation result indicates that the smart contract cannot validated (e.g., because erroneous behavior was detected), the smart contract may be rectified (e.g., in additional iterations of subprocess 340) and revalidated until a successful validation result is obtained. In an alternative embodiment, platform 110 may itself implement and perform the validation of smart contracts.

In subprocess 345, the smart contract 350 is deployed to blockchain 155. In particular, server application 112 may record the smart contract as a transaction on blockchain 155. Notably, in an on-chain implementation, smart contract 350 (i.e., compiled code) is itself stored on blockchain 155 and executed by nodes 152 of blockchain network 150.

In addition, smart contract 350 is associated with a unique address within the address space of blockchain 155. This address can be used to interact with the functions encoded in smart contract 350. Thus, the address may be provided to the parties to the agreement (e.g., first party and second party), to facilitate their subsequent interactions with and/or other utilizations of smart contract 350.

The unique address of smart contract 350 may be generated according to the particular scheme provided by blockchain network 150. Typically, the address will be created by applying a cryptographic hash algorithm to the data (e.g., code) and/or metadata (e.g., sender address) of smart contract 350 to produce a unique hash value that can then be used as the address. For example, in the Ethereum blockchain network, when a smart contract 350 is added to the blockchain in a transaction, a cryptographic hash algorithm is applied to a combination of the address (e.g., an address of an external account, such as a digital wallet) of the sender of the transaction and a nonce (i.e., how many transactions the sender has sent). The cryptographic hash algorithm may be the Secure Hash Algorithm 3 (SHA-3), and the sender's address and nonce may be combined using a Recursive Length Prefix (RLP) encoding function.

In an embodiment, at least some of the smart contracts 350, generated in subprocess 340 in the manner defined by the template selected in subprocess 335, are designed to encompass a plurality of different properties, such that the agreement, embodied in smart contract 350, can be subsequently expanded to include other properties. This may be implemented by incorporating functions for accepting different types of tokens (e.g., crypto tokens) in the code of smart contract 350.

Tokens are exchangeable units of values developed on top of blockchain network 150. The different types of tokens may have been previously created on blockchain 155, so that they are available for exchange on blockchain 155. Each type of token may itself be governed by a smart contract that implements functions, such as the method by which that type of token may be issued and exchanged and how users can access data regarding that type of token (e.g., balance of that type of tokens within an account, total supply of that type of token, etc.).

As one example, the Ethereum Request for Comments 1155 (ERC-1155) standard may be used to implement the smart contract that manages the different types of tokens. The ERC-1155 standard is a multi-token standard that supports both non-fungible tokens (NFTs) and fungible tokens, and uses a single smart contract to issue and otherwise manage different types of tokens. In particular, the ERC-1155 standard defines the interface that the smart contract for managing the tokens must implement. Advantageously, the ERC-1155 enables different types of tokens to be managed (e.g., transferred) together.

In an embodiment, a different type of token may be issued for each type of property managed by platform 110. For example, a first type of token may be issued for residential real property, a second type of token may be issued for commercial real property, a third type of token may be issued for automobiles, a fourth type of token may be issued for furniture, a fifth type of token may be issued for services, and so on and so forth. Once a smart contract 350 has been deployed for a particular agreement between the first party (e.g., lessee/purchaser) and the second party (e.g., lessor/seller), the smart contract 350 may be expanded by sending a token of the desired type to the unique address of the deployed smart contract 350. In an embodiment, all of the tokens may be fungible tokens.

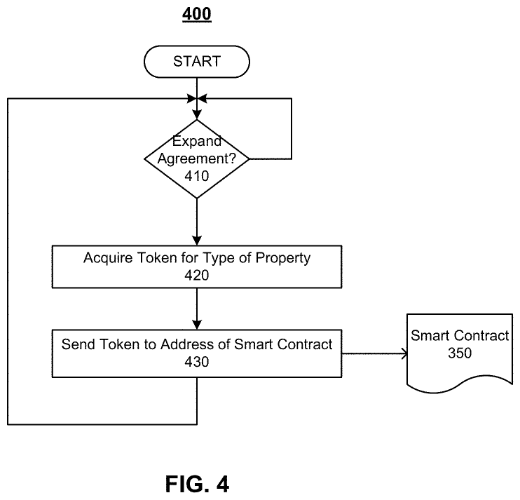

FIG. 4 illustrates an example process 400 for expanding an agreement represented by smart contract 350, according to an embodiment. Process 400 may be performed by a party (e.g., lessee/purchaser) to the existing agreement, represented by smart contract 350, using blockchain network 150.

For the purposes of illustration, the example of a lease agreement for a house will be used, and it is assumed that tokens of at least three different types have been created and are exchangeable in blockchain network 150: a house token; a furniture token; and a service token. It is also assumed that a first party (lessee) has already completed process 300 for a lease agreement for a house with a second party (lessor). Thus, smart contract 350 has been previously deployed to blockchain 155. The smart contract 350 may encode the payment terms of the lease agreement using logic that implements: at the start of each pay period, if termination condition T is not satisfied, transfer X house tokens from the first party's account (e.g., digital wallet) to the second party's account (e.g., digital wallet). It should be understood that X or other amount of house tokens may be transferred during deployment of smart contract (e.g., as a first payment or security deposit) in subprocess 345 of process 300, and will subsequently be transferred automatically by smart contract 350 (e.g., executing on a virtual machine) for each pay period.

In subprocess 410, the first party may decide to add furniture (e.g., refrigerator, couch, television, etc.) to the lease agreement. Thus, in subprocess 420, the first party may acquire a token for that type of property. In other words, the first party may acquire Y furniture tokens through a transaction on blockchain 155. For example, the first party may exchange an amount of cryptocurrency (e.g., Ether) or other token(s) for the Y furniture tokens. This transaction may be performed with another user of blockchain 155 (e.g., using that user's address) or may be performed with the smart contract that issues the furniture tokens (e.g., ERC-1155-compliant smart contract), using the smart contract's address In either case, the transaction is recorded on blockchain 155.

In subprocess 430, the first party may then send the acquired token(s) for the desired type of property in a request to smart contract 350. This request is recorded as a transaction between the first party and smart contract 350 on blockchain 155. For example, the first party may send Y furniture tokens in a request to the address of smart contract 350, representing a first lease payment for the furniture. Smart contract 350 may receive the Y furniture tokens and update its state to reflect that the lease agreement includes a lease of the furniture. For example, the request may include lease terms (e.g., payment terms), and smart contract 350 may update its stored state to reflect the lease terms. Subsequently, during each pay period, smart contract 350 may automatically transfer both X house tokens and Y furniture tokens from the first party's account to the second party's account.

It should be understood that process 400 may iterate over any number of iterations, such that the first party may add any number of additional properties to the existing lease agreement. For example, the first party may decide in a second iteration of subprocess 410 to add a service (e.g., Internet, television, telephone, house-cleaning, landscaping, pool-cleaning, etc.) to the lease agreement. In this case, the first party may acquire Z service tokens in subprocess 420, and send those Z service tokens to smart contract 350 in subprocess 430. Smart contract 350 will update its stored state to reflect the new lease terms, and subsequently, during each pay period, transfer X house tokens, Y furniture tokens, and Z service tokens from the first party's account to the second party's account.

It should also be understood that a smart contract (e.g., smart contract 350) may utilize off-chain data to perform one or more of its encoded functions. For instance, the smart contract may communicate with one or more external systems 140 to pull the data (e.g., via an API provided by external system(s) 140) from external system(s) 140. Alternatively, one or more external systems 140 may push the data to the smart contract (e.g., via a transaction on blockchain 155). In any case, the data may be used to determine whether a termination condition is satisfied, calculate amounts of tokens to transfer, and/or the like. As one example, the smart contract may be for the lease or rental of a vehicle, and the off-chain data may comprise speed, mileage, and/or other metrics collected by the vehicle (e.g., by an electronic control unit (ECU) of the vehicle). The smart contract may use this data to adjust a lease or rental payment for the vehicle (e.g., increasing or decreasing the payment based on mileage), calculate and transfer penalty payments (e.g., for speeding), calculate and transfer reward payments (e.g., for safe driving as represented by remaining under speed limits), and/or the like. As another example, the smart contract may be for the lease of a television, and the off-chain data may comprise a usage amount (e.g., number of minutes that the television is turned on) collected by the television or an Internet of Things (IoT) device connected to the television (e.g., monitoring power to the television). The smart contract may use this data to adjust a lease payment for the television that is proportional to the usage amount. It should be understood that there are many other examples of how various smart contracts may utilize data collected by external systems 140 (e.g., IoT devices, electronic controllers, etc.) to inform and/or trigger various functions implemented in the smart contracts.

The above description of the disclosed embodiments is provided to enable any person skilled in the art to make or use the invention. Various modifications to these embodiments will be readily apparent to those skilled in the art, and the general principles described herein can be applied to other embodiments without departing from the spirit or scope of the invention. Thus, it is to be understood that the description and drawings presented herein represent a presently preferred embodiment of the invention and are therefore representative of the subject matter which is broadly contemplated by the present invention. It is further understood that the scope of the present invention fully encompasses other embodiments that may become obvious to those skilled in the art and that the scope of the present invention is accordingly not limited.

Combinations, described herein, such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, and any such combination may contain one or more members of its constituents A, B, and/or C. For example, a combination of A and B may comprise one A and multiple B's, multiple A's and one B, or multiple A's and multiple B's.

What is claimed is:

1. A method comprising using at least one hardware processor to:
receive one or more search criteria from a first user;
search a database of a plurality of properties based on the one or more search criteria to produce search results comprising one or more of the plurality of properties;
receive a selection of at least one property, associated with a second user, from the one or more properties in the search results;
receive one or more user operations from one or both of the first user or the second user representing approval of an agreement associated with the at least one property; and,
after approval of the agreement,
select a template for a smart contract, from a plurality of available templates, based on one or both of the agreement or the at least one property,
generate a smart contract based on the template and one or both of the agreement or the at least one property,
compile the smart contract, and
deploy the compiled smart contract on a blockchain.

2. The method of claim 1, wherein the smart contract comprises one or more functions for accepting a plurality of different types of tokens that are each exchangeable on the blockchain.

3. The method of claim 2, wherein the plurality of different types of tokens comprises a token type representing each of a plurality of different types of property.

4. The method of claim 3, wherein the smart contract is configured to, when receiving a request with a token representing a new type of property, update a stored state, representing the agreement, to include the new type of property.

5. The method of claim 3, wherein the plurality of different types of property comprises real property and personal property.

6. The method of claim 5, wherein the plurality of different types of property further comprise a service.

7. The method of claim 2, further comprising deploying a single smart contract on the blockchain to generate and manage the plurality of different types of tokens.

8. The method of claim 7, wherein the single smart contract complies with Ethereum Request for Comment 1155 (ERC-1155) standard.

9. The method of claim 1, wherein the template comprises source code of the smart contract and one or more placeholders configured to receive parameter values specific to the agreement.

10. The method of claim 1, wherein the agreement is a lease agreement.

11. The method of claim 10, wherein the smart contract is configured to automatically execute a transfer of value on the blockchain from a digital wallet of the first user to a digital wallet of the second user according to a payment term in the agreement.

12. The method of claim 11, wherein the transfer of value comprises a transfer of an amount of tokens.

13. The method of claim 1, further comprising using the at least one hardware processor to, prior to deploying the compiled smart contract, validate a behavior of the compiled smart contract.

14. The method of claim 1, further comprising using the at least one hardware processor to:
receive property data for the at least one property from the second user via an application programming interface or a graphical user interface;
generate a unique property identifier for the at least one property; and
store the property data in the database of the plurality of properties in association with the unique property identifier.

15. The method of claim 14, further comprising using the at least one hardware processor to:
receive one or more media for the at least one property from the second user via an application programming interface or a graphical user interface; and
store the one or more media in a media database, which is separate from the database of the plurality of properties, in association with the unique property identifier.

16. The method of claim 1, wherein receiving the one or more user operations comprises:
receiving a selection of a call-to-action input, indicating acceptance of the agreement, by the first user within a graphical user interface;
providing an approval request to the second user; and
receiving an acceptance of the agreement from the second user.

17. The method of claim 16, wherein receiving the one or more user operations further comprises, prior to providing the approval request to the second user:
communicating with one or more external systems over at least one network to perform one or more of a verification process, security authentication process, or credit approval process on the first user; and
receiving a result from the one or more external systems,
wherein the approval request comprises an indication of the result.

18. The method of claim 1, wherein receiving a selection of at least one property comprises receiving a selection of one or more options from a plurality of available options for terms of the agreement associated with the at least one property.

19. A system comprising:
at least one hardware processor; and
one or more software modules that are configured to, when executed by the at least one hardware processor,
receive one or more search criteria from a first user,
search a database of a plurality of properties based on the one or more search criteria to produce search results comprising one or more of the plurality of properties,
receive a selection of at least one property, associated with a second user, from the one or more properties in the search results,
receive one or more user operations from one or both of the first user or the second user representing approval of an agreement associated with the at least one property, and,
after approval of the agreement,
select a template for a smart contract, from a plurality of available templates, based on one or both of the agreement or the at least one property,
generate a smart contract based on the template and one or both of the agreement or the at least one property,
compile the smart contract, and
deploy the compiled smart contract on a blockchain.

20. A non-transitory computer-readable medium having instructions stored therein, wherein the instructions, when executed by a processor, cause the processor to:
receive one or more search criteria from a first user;
search a database of a plurality of properties based on the one or more search criteria to produce search results comprising one or more of the plurality of properties;
receive a selection of at least one property, associated with a second user, from the one or more properties in the search results;
receive one or more user operations from one or both of the first user or the second user representing approval of an agreement associated with the at least one property; and,
after approval of the agreement,
select a template for a smart contract, from a plurality of available templates, based on one or both of the agreement or the at least one property,
generate a smart contract based on the template and one or both of the agreement or the at least one property,
compile the smart contract, and
deploy the compiled smart contract on a blockchain.
